(19) United States
(12) Patent Application Publication
(10) Pub. No.: US 2007/0273325 A1
(43) Pub. Date: Nov. 29, 2007

(54) Power station with built in battery charger

(75) Inventors: Michael Krieger, Miami Beach, FL (US); Kevin Ellsworth, Alva, FL (US)

Correspondence Address: VECTOR PRODUCTS, INC.;ROBERT POWELL, P.O. BOX 34385, c/o VENABLE LLP, WASHINGTON, DC, 20043-9998, US

(73) Assignee: Black & Decker Inc., Newark, DE (US)

(21) Appl. No.: 11/710,440

(22) Filed: Feb. 26, 2007

Related U.S. Application Data
(60) Provisional application No. 60/776,237, filed on Feb. 24, 2006.

(51) Int. Cl. H02J 7/00; H02M 3/22

(52) U.S. Cl. 320/106; 320/107; 363/142

(57) ABSTRACT

A power station is provided. The power station may be designed as a versatile, portable power station addressing the most common needs of power for a consumer. The power station preferable can provide DC power, AC power, portable battery charging capability, and other power providing capabilities.

### BACKGROUND OF THE INVENTION

Today, people are highly mobile and require that their electronic tools with which they conduct their business be likewise mobile. Part of meeting that requirement is to provide portable electronic devices, such as cellular phones and laptop computers, with the power those devices need. Portable devices are usually equipped with chargeable batteries, but even the most expensive and heavy batteries are rarely sufficient to deliver electrical power over a significant time period. These batteries need to be charged periodically from various power sources, sometimes on the road.

Chargeable cells, such as nickel-cadmium cells, have a relatively constant potential during discharge and can be charged many times, thus extending their useful life. In general, any chargeable cell contains a combination of active materials which can be electrolytically oxidized and reduced repeatedly. In chargeable cells, reactions at both electrodes are reversible and the input of current in the appropriate direction from an outside source will reverse the discharge reaction and, in effect, charge the electrodes.

The chargeable cells have been used in various types of devices, such as toys, calculators, radios and other types of power-operated devices. Many of the power-operated devices on the market today have been designed to accommodate cylindrical cells of the “AAA”, “AA”, “C”, and “D” size. These sizes have now become standard-type cell sizes having overall dimensions which can be found in various publications, such as The American National Standard Specifications For Dry Cell Batteries—ANSI C18.1-1969 published by the American National Standards Institute, Inc., New York, N.Y.

Many portable electronic devices rely on one or more single-cell batteries for power. The plethora of different electronic devices, such as pagers, cellular phones, portable radios, portable CD players, flashlights, and other battery powered electronic equipment in use has created a great volume demand for single-cell battery power, resulting in the sale of both chargeable and non-chargeable single-cell batteries.

Chargeable batteries, such as nickel cadmium (NiCd) are available in conventional and identical sizes and substantially identical voltages as the non-chargeable single cell batteries and are often used interchangeably with non-chargeable batteries. The interchangeable use of either chargeable or non-chargeable small single cell batteries creates a problem for the user to distinguish between the chargeable or non-chargeable batteries, especially when dealing with a battery charger. To insert a non-chargeable battery into a single cell battery charger creates a hazardous condition that can result in injury or damage due to leakage of chemicals from the non-chargeable battery when recharging is accidentally attempted.

Applicant knows of no single device that can provide diverse sources of power as well as portable battery charging capability. Thus, there is a need for a device that can address the power needs generated by consumer power requirements.

### SUMMARY OF THE INVENTION

In an exemplary embodiment of the invention, a power station is provided. The power station may be designed as a versatile, portable power station addressing the most common needs of power for a consumer. The power station preferably may provide DC power, AC power, portable battery charging capability, and other power providing capabilities.

In another embodiment of the invention, the portable power station comprises a housing; an AC port provided on the housing; a DC port provided on the housing; an internal battery disposed within the housing and coupled to the DC port; a power inverter disposed in the housing and receiving DC input and providing AC output to the AC port; portable battery charger circuitry disposed in the housing, the battery charger circuitry providing charging current to the internal battery and/or to portable batteries inserted into the housing.

In another embodiment of the invention, the portable power station comprises a housing; an AC outlet provided on the housing; a DC input; an internal battery disposed within the housing; a power inverter disposed in the housing and receiving the DC input and providing AC output to the AC outlet; portable battery charger circuitry disposed in the housing, the battery charger circuitry coupled to the DC input or internal battery and providing charging current for portable batteries.

### BRIEF DESCRIPTION OF THE DRAWINGS

FIG. 1 is a perspective view of an exemplary embodiment of a portable power station according to the invention; and

FIG. 2 is a perspective view of another exemplary embodiment of a portable power station according to the invention;

FIG. 3 is a block diagram illustrating the components of the portable power station according to an exemplary embodiment of the invention; and

FIG. 4 is a perspective view of an exemplary embodiment of a cavity within the portable power station according to the invention.

### DETAILED DESCRIPTION OF A PREFERRED EMBODIMENT

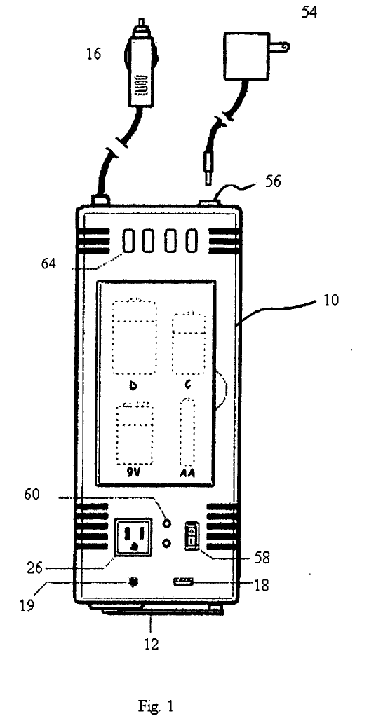

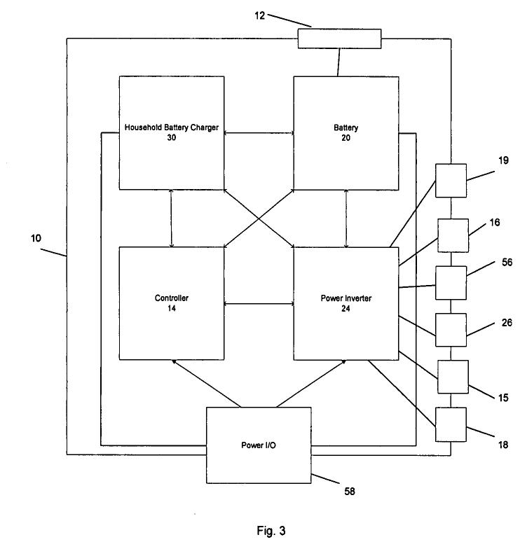

The portable power station, shown in FIGS. 1-4, includes a housing 10. A power source, for example a battery 20 such as a sealed lead acid battery, a nickel cadmium battery, a nickel metal hydride battery or the like, may be disposed in the housing 10 (FIG. 3). A hand cranked dynamo 12 may also be provided. The dynamo 12 may provide power, for example, to charge the battery 20 in the event of a power outage or if power is otherwise unavailable. Additionally, the battery 20 can provide power for a controller 14, such as a microprocessor or other circuitry that is used to control the operation of the various components of the power station. The battery 20, may also provide power to the battery charger 30.

The battery 20 may also provide a portable DC power source that can be used to operate various external devices when other power sources are not available. Also, the DC power from the battery 20 or another DC power source may be converted into an AC power supply. This feature is very useful to consumers where an AC outlet is inaccessible or inconvenient.

In order to provide an AC power output, the power station may include a power inverter 24, for example the power inverter described in U.S. patent application Ser. No. 10/214,340 which is incorporated herein by reference. The power inverter 24 may be housed within the housing 10. The power inverter may convert a DC power input into an AC output, such as a 120V household current output. The DC power may be provided, for example, from a vehicle battery via a cigarette lighter adapter 16, the internal battery 20, or other DC power sources via a DC input port 56. Receptacle 26, adapted to receive a typical AC plug, may be provided on the housing 10 and coupled to the power inverter 24 to provide AC power to an external device plugged therein.

The power inverter 24 may also convert AC to DC. When converting AC to DC, an output of the power inverter 24 may be coupled to a DC power outlet or to battery 20, if present, an AC power source may be coupled to an AC power input, and the AC input port may be coupled to the power inverter 24. Several different types of DC power outlets may be provided. For example, USB port 18 may be provided on the housing. The USB port 18 may be used to provide a USB power supply. In embodiments of the invention, a voltage regulator, optionally included in the power inverter 24, may convert DC input power, for example, from a 12 V DC input or the battery 20, into a USB compatible 5V/500 mA DC power output. A charging port 19 (FIG. 1) for mobile telephones or other portable devices may also be provided. In embodiments of the invention, the DC power outlets may be adapted to receive power from the dynamo 12, the battery 20, a DC power input and/or the power inverter 24.

The power station can also be provided with a household battery charger circuit 30. Referring to FIG. 3, the household battery charger circuit 30 is adapted to charge portable chargeable batteries, such as NiCad batteries and the like. As defined herein, portable batteries comprise any rechargeable portable battery designated as such by any of the American National Standard Specifications as published by the American National Standards Institute, such as ANSI C18 series. Exemplary portable batteries are designated as AAA, AA, C and D and have wide household use.

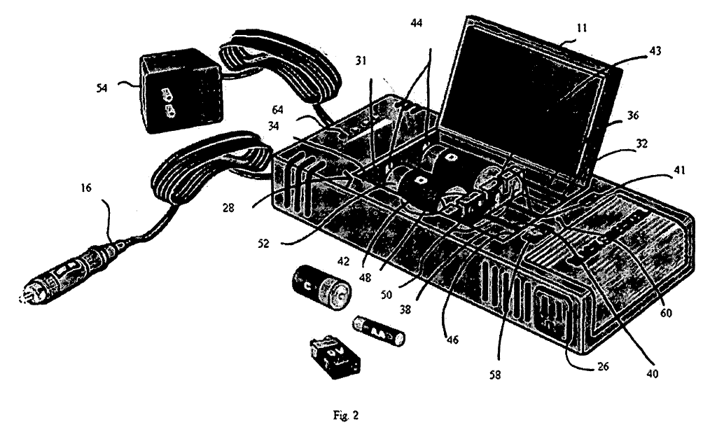

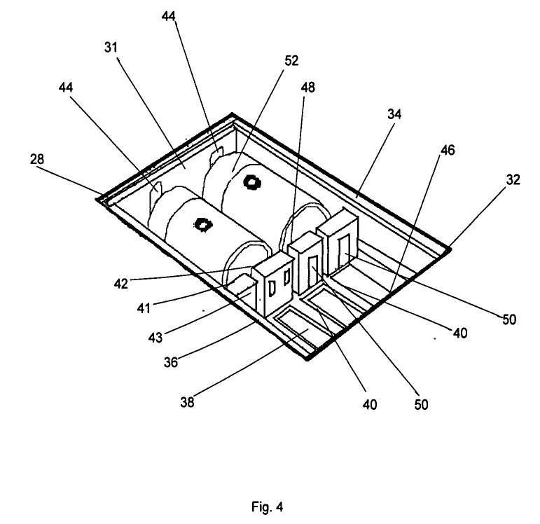

Referring now to the embodiment illustrated in FIG. 2, the housing has a lid 11. The lid 11 may be opened or closed to expose or enclose a cavity 28 within the housing 10. Latches or other securing devices may be provided to secure the lid 11 in the closed position. The cavity 28 may be adapted to accommodate portable batteries of different size and type, such as a 9 volt battery and D, C, AA, etc. size cells. As shown in FIGS. 2 and 4, the cavity 28 may have a rectangular shape, with a top 31, bottom 32 and two sides 34, 36. A back 38 may connect the top 30, bottom 32 and two sides 34, 36 together. The top 30 and bottom 32 may be provided with various contacts 44, 46, respectively, to connect to the contacts of different size and type batteries. The back 38 may be provided with slots 40 extending along at least part of the back's 38 length or width. A slide member 41 may move along the slots 40.

The slide member 41 may have a front surface 42 facing top 31 and a back surface 43 facing bottom 32. Various sets of contacts 48, 50 may be provided on the front surface 42 and the back surface 43, respectively. The contacts 48, 44 on front surface 42 and top 31 may be adapted to connect to battery electrodes of opposite polarity. The contacts 50, 46 on back surface 43 and bottom 32 may be adapted to connect to battery electrodes of opposite polarity. For example, positive electrodes of batteries 50 may be connected to contacts 44 and negative electrodes of batteries 52 may be connected to contacts 48 on front surface 42. The slide member 41 may move along the slots to fit different size batteries. Cavity 28 may also be adapted to receive and charge batteries of different sizes in a variety of other ways which are known to one of ordinary skill in the art.

In a further embodiment, the portable battery charger may detect if chargeable or non-chargeable batteries are placed in the cavity 28. Detection may be made by controller 14. The detection may be based on the characteristics of the portable battery, such as voltage, internal resistance, etc. If a non-chargeable battery is detected, charging is prevented. Detecting and preventing the charging of non-chargeable batteries may be done in a known manner.

The portable batteries may be charged via the DC input, the battery 20, DC output from the power inverter, or via a wall cube 54 that converts household AC current into DC. A DC input port 56 may be provided on the housing to receive input from the wall cube 54. The internal battery 20 may also be charged in these ways.

An on/off switch 58 controls the operation of the power station. A pair of indicator lights 60 may be provided to indicate the status of the power station and its components. Another set of indicator lights 64 may be provided to show the status of the internal battery 20 or portable batteries being charged. The controller may monitor the various components of the power station and show results on a display. The display may include a linear meter, a digital read out or a bar graph for a user to monitor the operation of the power station.

Numerous different options are contemplated within the apparatus electrically, these options may include such schemes as totally enclosing the internal wiring terminating at a single point input/outlet for all charging functions or, conversely, at multiple points both internal and external. The power inverter, battery charger and other devices may be of varying watts, amperage ratings, etc. The battery configuration may include several different types of technology such as nickel cadmium, lead acid, etc. A port may be provided in the power station to allow for the addition of external batteries of greater capacity than the internal battery. Each of the aforementioned devices are contained within the same housing for a portable power station. The power station can provide both DC and AC power in addition to battery charging capabilities.

We claim:

1. A portable power station, comprising:
a housing defining a cavity therein, the cavity being adapted to receive different size rechargeable batteries;
an AC outlet provided on the housing;
at least one DC input port;
a battery disposed within the housing;
a power inverter disposed in the housing, the power inverter configured to receive a DC input from the battery or the DC input port and provide an AC output to the AC outlet;
a portable battery charging circuitry disposed in the housing, the battery charger circuitry coupled to at least one DC input and the internal battery, and providing battery charging current to portable batteries in the cavity.

2. The portable power station of claim 1, wherein the battery charging circuitry is adapted to distinguish between chargeable and non-chargeable batteries.

3. The portable power station of claim 1, further comprising:
a lid hingedly connected to the housing and adapted to cover the cavity;
a slide member disposed in the cavity, the slide member being movable to accommodate different size portable batteries;
a first set of recharging contacts disposed on a top side of the cavity and a corresponding set of battery contacts provided on a first side of the slide member; and
a second set of recharging contacts disposed on a bottom side of the cavity and a corresponding set of battery contacts provided on a second side of the slide member, opposite the first side of the slide member.

4. The portable power station of claim 1, further comprising:
a hand cranked dynamo coupled to the battery.

5. The portable power station of claim 1 further comprising a controller coupled to the portable battery charger, the battery, and the power inverter.

6. The portable power station of claim 1, further comprising a cigarette lighter adaptor coupled to one of the DC input port.

7. The portable power station of claim 6 further comprising at least one DC output port.

8. The portable power station of claim 7, wherein the DC output port is adapted to output a USB compatible power output.

9. The portable power station of claim 7 wherein the DC output port is adapted to charge a mobile telephone.

10. The portable power station of claim 2, wherein the portable battery charging circuitry is adapted to charge only chargeable batteries.

11. The portable power station of claim 7 wherein the power inverter is configured to receive an AC input from an AC input port and provide a DC output to the battery, the portable battery charging circuit, or a DC output port.

12. The portable power station of claim 1, further comprising:
a first set of indicator lights configured to indicate the status of at least one of the portable battery charger or the power inverter.

13. The portable power station of claim 1, further comprising:
a second set of indicator lights configured to indicate the status of at least one of the battery or the portable batteries.

14. The portable power station of claim 1, further comprising:
a display connected to the portable battery charging circuit.

15. An apparatus, comprising:
a housing; and
circuitry disposed within the housing coupled to a battery, a portable battery charger, a power inverter, a controller, at least one of a AC or DC input port, and at least one of an AC or DC output port:
the battery adapted to receive a DC input from the DC input port or the power inverter and provide a DC output, and coupled to the controller, the portable battery charger, and at least one of the DC output ports;
the power inverter adapted to receive a DC or AC input from at least one of the AC inputs, the DC inputs, or the battery, and provide a DC or AC output, and coupled to the controller, the portable battery charger, and at least one of the AC or DC output ports;
the portable battery charger adapted to receive a DC input from at least one of the battery, the DC input port, or the power inverter charger, to contain at least one rechargeable battery and provide DC input to the at least one rechargeable battery; and
the controller adapted to receive DC input from at least one of the battery, the DC input port, or the power inverter, regulate the operation of the battery, the portable battery charger, and the power inverter.

16. The apparatus of claim 15, wherein the portable battery charger is adapted to distinguish between rechargeable and non-rechargeable batteries.

17. The apparatus of claim 15, further comprising:
a lid hingedly connected to the housing and adapted to cover the cavity, the lid including contours adapted to fit the contour of different size batteries to hold the batteries within the cavity.

18. The apparatus of claim 15, further comprising:
a lid hingedly connected to the housing and adapted to cover the cavity;
a slide member disposed in the cavity, the slide member being movable to accommodate different size portable batteries;
a first set of recharging contacts disposed on a top side of the cavity and a corresponding set of battery contacts provided on a first side of the slide member; and
a second set of recharging contacts disposed on a bottom side of the cavity and a corresponding set of battery contacts provided on a second side of the slide member, opposite the first side of the slide member.

19. The apparatus of claim 15, further comprising a cigarette lighter adaptor coupled to the DC input port.

20. The apparatus of claim 15, further comprising a USB port configured to output DC power.

21. The apparatus of claim 15, further comprising a set of indicator lights disposed on the housing configured to indicate the status of the least one of the battery, the portable battery charger, or the power inverter.

22. The apparatus of claim 15, further comprising a set of indicator lights configured disposed on the housing to indicate the status of at least one of the battery, the portable batteries, or the power inverter.

23. The apparatus of claim 15, further comprising a display disposed on the housing configured to indicate the status of at least one of the battery, the portable battery charger, or the power inverter.
